(19) United States
(12) Patent Application Publication
(10) Pub. No.: US 2013/0042427 A1
(43) Pub. Date: Feb. 21, 2013

(54) WIPER LINKAGE

(71) Applicant: Joachim Zimmer, Shanghai (CN)

(72) Inventor: Joachim Zimmer, Shanghai (CN)

(73) Assignee: ROBERT BOSCH GMBH, Stuttgart (DE)

(21) Appl. No.: 13/579,332

(22) PCT Filed: Dec. 27, 2010
(86) PCT No.: PCT/EP10/70758

§ 371 Date: Oct. 29, 2012

(30) Foreign Application Priority Data
Feb. 16, 2010 (DE) 10 2010 001 968.2

(51) Int. Cl. B60S 1/34; F16H 21/40

(52) U.S. Cl. 15/250.34; 74/47

(57) ABSTRACT

A wiper linkage of a windscreen washing system for a motor vehicle, comprising a motor crank (10) with a first end section (14) and a second end section (16), wherein the motor crank (10) is connected at its first end section (14) to a drive motor via a connecting element (12), and wherein the motor crank (10) has, at its second end section (16), a double ball pin (18) which is connected to a first joint rod (20) and to a second joint rod (22), wherein by means of a rotational movement of the motor crank (10) a first crank radius (28) can be transmitted to the first joint rod (20) and a second crank radius (34) can be transmitted to the second joint rod (22), wherein according to the invention the first crank radius (28) of the first joint rod (20) has a different size from the second crank radius (34) of the second joint rod (22).

### BACKGROUND OF THE INVENTION

The invention relates to a wiper linkage of a windshield wiper system for a motor vehicle.

Wiper linkages customarily have a motor crank which is connected to an output shaft of a driving motor, in particular of a wiper motor, via which output shaft the motor crank is driven by the driving motor. A ball pin or a double ball pin is customarily provided on the motor crank and, in the case of a double ball pin, a first articulated rod for a first windshield wiper and a second articulated rod for a second windshield wiper are arranged thereon. This results in synchronized windshield wiper arms, one acting on the driver's side and one on the passenger's side. In order to obtain forces which are as low as possible at the articulated rods, the motor crank customarily has a relatively great length. This results in a large radius of the motor crank trajectory which, together with the customarily small ratio of crank radius to rod length of approx. 1/4 to 1/7, requires a correspondingly large construction volume and a correspondingly required movement space for the wiper linkage. Typical synchronizing systems of two windshield wiper arms have a significantly larger wiping angle on the passenger's side than on the driver's side. With the nowadays customary identical motor crank radius for the drive on the driver's side and passenger's side, this results in unequal oscillation lengths for the windshield wiper arms, which are connected via the articulated rods, at the two driving axes of the wiper linkage. A customarily used synchronizing wiper system with wiping angles of 80° on the driver's side and of 90° on the passenger's side and with a motor crank radius of 45 mm in both cases has resulting oscillating radii of the windshield wiper arm of 70.2 mm on the driver's side and resulting oscillating radii of the windshield wiper arm of 63.5 mm on the passenger's side. This is disadvantageous in particular for the passenger's side, since only a short oscillating length is produced for said relatively long windshield wiper arm. This in turn results in an unfavorable transmission ratio between the two driving oscillating lengths. The disadvantages include relatively large wiping angle tolerances and increased internal forces in the wiper drive due to the short oscillating length. Furthermore, this effect is reinforced when used in reversing systems. In the case of a rotor motor, the motor crank rotates through 360° for a wiping cycle. In the case of wiper linkages having reversing motors, the motor crank working angle is typically at around 145° to 165°. In comparison to the rotary motor, this results in a reduction in the working path of the ball pin of approx. 8-19%. At this ratio, both oscillating lengths have to be reduced further in order to set the required wiping angles, and therefore, due to the small effective lever arms, an increase in the internal forces in the wiper system again results. Said high internal forces and the unfavorable ratio between windshield wiper arm length and oscillating length make the wiping system sensitive to external disturbances, which may result in rattling of the windshield wiper arms, and therefore the advantages which the reversing system with rotational speed control has do not come to bear.

### SUMMARY OF THE INVENTION

It is therefore the object of the invention to make available a wiper linkage of a windshield wiper system for a motor vehicle, that has improved kinematics, as a result of which the functional quality of the wiper linkage can be improved and the use options thereby expanded.

The wiper linkage according to the invention of a windshield wiper system for a motor vehicle has a motor crank with a first end section and a second end section, wherein the motor crank is connected at the first end section thereof to a driving motor via a connecting element, and wherein the motor crank has, at the second end section thereof, a double ball pin which is connected to a first articulated rod and a second articulated rod, wherein a first crank radius is transmittable to the first articulated rod and a second crank radius is transmittable to the second articulated rod by a rotational movement of the motor crank. The invention is distinguished in that the first crank radius of the first articulated rod differs in size from the second crank radius of the second articulated rod.

This wiper linkage according to the invention is designed in the form of what is referred to as a central output wiper linkage which is provided for wiper systems with two windshield wiper arms. The motor crank is connected at the first end section thereof via a connecting element, preferably in the form of an output shaft of the driving motor, via which output shaft the motor crank can execute a pivoting movement about the axis of symmetry of the connecting element in order to realize one or two crank radii. At the second end section thereof, the motor crank has a double ball pin on which a first articulated rod for a first windshield wiper arm and a second articulated rod for a second windshield wiper arm are arranged. For example, the first articulated rod may be designed for a windshield wiper arm for the driver's side and the second articulated rod for a windshield wiper arm for the passenger's side. By means of a rotational movement of the motor crank during a wiping operation, a first crank radius is transmitted to the first articulated rod and a second crank radius to the second articulated rod, wherein, in the case of the known wiper linkages, provision is made for said two crank radii to be designed to be equal in size. According to the invention, provision is now made for the first crank radius of the first articulated rod to differ from the second crank radius of the second articulated rod, and therefore said crank radii are now no longer identical in size. The wiper linkage according to the invention is therefore now designed with two different crank radii at the motor crank. The two different motor crank radii here are adjusted so as to result in optimized kinematics in the wiping movement of the wiper linkage. The different crank radii, which are optimally matched to each other, result in substantially identically sized oscillating radii for the articulated rods or the windshield wiper arms on the driver's side and on the passenger's side. This makes it possible to very substantially reduce the otherwise customary differences in oscillating length between the windshield wiper arm of the driver's side and the windshield wiper arm of the passenger's side, and therefore wiping angle tolerances of the windshield wiper arms can be reduced. In the case of use of wiper linkages having identical oscillating lengths of the windshield wiper arms, the robustness in relation to external disturbances is increased, thus making it possible to reduce the tendency of the windshield wiper arms to rattle and thereby allowing an improvement in the system performance in critical environmental conditions. This is advantageous especially in the case of reversing systems, since disadvantages due to the basically smaller crank working angle can be compensated for here. Furthermore, owing to lower internal forces, smaller dimensioning of the individual components of the wiper linkage is possible, thus opening up possibilities for reducing cost and weight.

Provision is preferably made for the double ball pin to have an axis of symmetry which is provided at an angle to the axis of symmetry of the connecting element. In this case, the axis of symmetry of the double ball pin is arranged with respect to the axis of symmetry of the connecting element in such a manner that said axes of symmetry now no longer run parallel to each other, as has customarily been provided, but rather are tilted with respect to each other or inclined with respect to each other. In this case, angled means that the axes of symmetry do not run parallel to each other. This configuration makes it possible in a simple and cost-effective manner to realize different crank radii of the first articulated rod and second articulated rod.

In this case, provision is preferably made for the axis of symmetry of the double ball pin to be inclined in the direction of the axis of symmetry of the connecting element. This makes it possible to adjust the articulated rod crank radius, which is provided on the double ball pin closer to the motor crank, to be larger than the articulated rod crank radius which is arranged further away from the motor crank on the double ball pin. As a result, it is possible not to increase the effective construction space requirement since, as a rule, the required working region of the articulated rod or of the wiper arm of the wiper linkage that is arranged furthest away from the motor crank on the double ball pin is the decisive factor for the construction space requirement and for the packaging of the wiper linkage. The articulated rod which is arranged closer to the motor crank on the double ball pin is preferably the articulated rod on which the windshield wiper arm for the passenger's side is provided, and therefore the crank radius of the articulated rod or of the windshield wiper arm for the passenger's side is larger than the crank radius of the articulated rod or of the windshield wiper arm for the driver's side.

As an alternative, provision is preferably made for the axis of symmetry of the double ball pin to be inclined away from the axis of symmetry of the connecting element. As a result, a larger crank radius, and therefore a larger output angle or wiping angle, is produced for the articulated rod which is arranged furthest away from the motor crank on the double ball pin than for the articulated rod which is arranged closer to the motor crank on the double ball pin.

The angled arrangement of the axis of symmetry of the double ball pin with respect to the axis of symmetry of the connecting element is preferably realized in that the second end section of the motor crank is formed at an angle to the first end section of the motor crank. The angled arrangement of the first end section with respect to the second end section means that the second end section is not arranged parallel to the first end section but rather is provided in a sloping manner with respect thereto. As a result, it is possible in a particularly simple manner to realize an angled arrangement of the axis of symmetry of the double ball pin with respect to the axis of symmetry of the connecting element without having to configure the connecting element or the double ball pin in a different manner. The motor crank itself is preferably designed as a rod or an elongate plate which has an angled region.

The angled arrangement of the second end section of the motor crank with respect to the first end section of the motor crank is preferably realized by the motor crank having a single offset. In the case of a single offset, the motor crank has a single angled region, as a result of which an angled arrangement of the second end section with respect to the first end section is realized.

As an alternative thereto, it is possible for the motor crank to have a double offset. In the case of the double offset, the motor crank has a respective angled region of the motor crank at two different locations along the longitudinal axis thereof, as a result of which an angled arrangement of the second end section with respect to the first end section is realized via two angled regions.

Furthermore, the invention relates to a windshield wiper system for a motor vehicle comprising a wiper linkage designed and developed as above.

### BRIEF DESCRIPTION OF THE DRAWINGS

The invention is explained in more detail below using preferred exemplary embodiments and with reference to the attached drawings, in which:

FIG. 1 shows a schematic illustration of an arrangement of a synchronizing wiper system according to the prior art;

FIG. 2 shows a schematic illustration of a wiper linkage according to the prior art;

FIG. 3 shows a further schematic illustration of a wiper linkage according to the prior art;

FIG. 4 shows a schematic illustration of the ratio of the crank radii of the motor crank to the oscillating lengths of the articulated rods and of the windshield wiper arms in the case of a wiper linkage according to the prior art;

FIG. 5 shows a schematic illustration of the ratio of the crank radii of the motor crank to the oscillating lengths of the articulated rod and of the windshield wiper arms in the case of a wiper linkage according to the invention in a rotary mode;

FIG. 6 shows a schematic illustration of the ratio of the crank radii of the motor crank to the oscillating lengths of the articulated rod and of the windshield wiper arms in the case of a wiper linkage according to the invention in a reversing mode;

FIG. 7 shows a schematic illustration of a first embodiment of a wiper linkage according to the invention;

FIG. 8 shows a schematic illustration of a second embodiment of a wiper linkage according to the invention;

FIG. 9 shows a schematic illustration of a third embodiment of a wiper linkage according to the invention.

### DETAILED DESCRIPTION

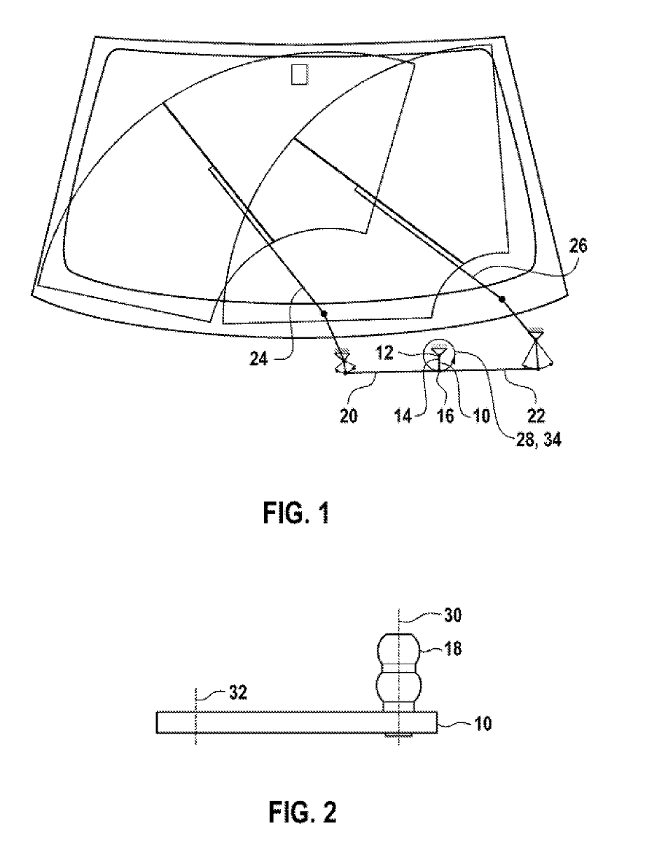

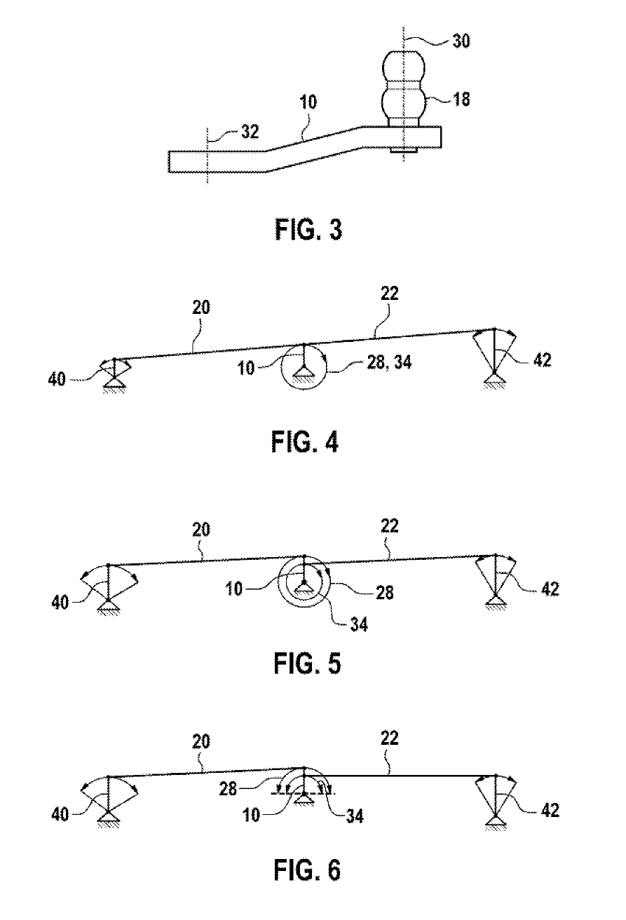

FIG. 1 shows a schematic illustration of an arrangement of a synchronizing wiper system with a known wiper linkage of a windshield wiper system for a motor vehicle, said wiper linkage having a motor crank 10 which is connected via a connecting element 12 in the form of an output shaft to a driving motor. In this case, the motor crank 10 is connected at a first end section 14 to the connecting element 12. At the second end section 16 opposite the first end section 14, the motor crank has a double ball pin 18, as illustrated in FIG. 2 and FIG. 3, on which a first articulated rod 20 and a second articulated rod 22 (not illustrated in FIG. 2 and FIG. 3) are provided. A windshield wiper arm 24 which is provided for the passenger's side of the motor vehicle is arranged on the first articulated rod 20, and the second articulated rod 22 is connected to a windshield wiper arm 26 which is arranged on the driver's side of the motor vehicle. This known synchronizing wiper system has a crank radius of identical size, depicted by the circle 28, for the first articulated rod 20 and for the windshield wiper arm 24 of the passenger's side and for the second articulated rod 22 and for the windshield wiper arm 26 of the driver's side. The identical crank radii for the first articulated rod 20 and the second articulated rod 22 result in different wiping angles of the two windshield wiper arms 24, 26, since, owing to the crank radii 28, 34 of identical size, different oscillating lengths of the windshield wiper arms 24, 26 are produced.

In the case of synchronizing wiper systems of this type, as illustrated in FIG. 2 and FIG. 3 and which are known from the prior art, the double ball pin 18 is arranged with respect to the connecting element 12 in such a manner that the axis of symmetry 30 of the double ball pin 18 is arranged parallel to the axis of symmetry 32 of the connecting element 12. The parallel arrangement of the two axes of symmetry 30, 32 is independent of whether the motor crank 10 is of a planar design along the longitudinal axis thereof, as shown in FIG. 2, or else has an offset or a double offset, as shown in FIG. 3.

FIG. 4 shows once again a comparison of the crank radius 28 of the first articulated rod 20 and of the resultant oscillating length 40 of the windshield wiper arm 24 of the passenger's side to the crank radius 24 of the second articulated rod 22 and the resultant oscillating length 42 of the windshield wiper arm 26 of the driver's side in the case of the synchronizing wiper systems known from the prior art, wherein different oscillating lengths 40, 42 for the windshield wiper arm 24 of the passenger's side and the windshield wiper arm 26 of the driver's side result owing to the identical crank radii 28, 34. In this case, the oscillating length 40 for the passenger's side is very small, whereas the oscillating length 42 for the driver's side is very large. As a result, the windshield wiper arm 24 of the passenger's side has a large driving angle, whereas the windshield wiper arm 26 of the driver's side has a small driving angle.

By contrast, FIG. 5 and FIG. 6 both show a schematic illustration of the ratio of the crank radii 28, 34 to the oscillating lengths 40, 42 for a synchronizing wiper system of a wiper linkage according to the invention, wherein the first articulated rod 20 in this case has a crank radius 28, 34 which differs from the second articulated rod 22. FIG. 5 shows the wiper linkage according to the invention for a rotary mode and FIG. 6 shows the wiper linkage according to the invention for a reversing mode. In the case of the wiper linkage according to the invention, the crank radius 28 of the first articulated rod 20 is larger than the crank radius 34 of the second articulated rod 22. As a result, both the windshield wiper arm 24 of the passenger's side and the windshield wiper arm 26 of the driver's side have a large oscillating length 40, 42. This results in optimum kinematics for the wiper linkage with wiping angle tolerances which are as small as possible at the same time. In addition, owing to the greater oscillating lengths 40, 42 which can be obtained, smaller internal forces act in the wiper drive.

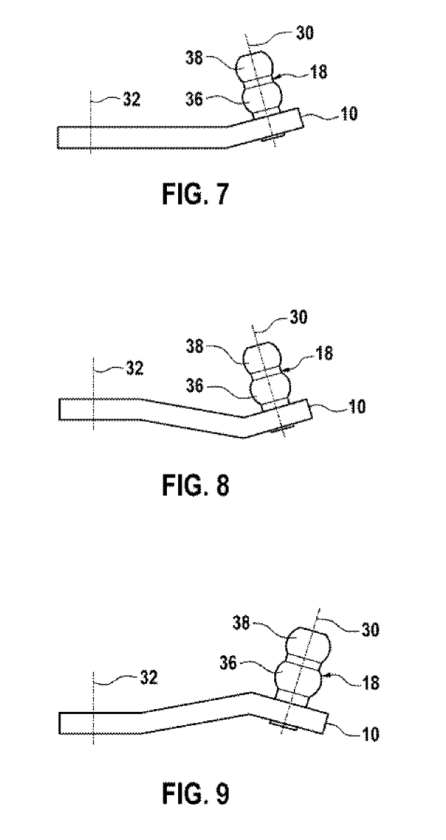

The different crank radii 28, 34 can be realized in this case in that, as FIGS. 7 to 9 show, the axis of symmetry 30 of the double ball pin 18 is formed at an angle to the axis of symmetry 32 of the connecting element 12, and therefore the axes of symmetry 30, 32 no longer run parallel to each other here. The first articulated rod 20 for the passenger's side is preferably arranged on that ball pin 36 of the double ball pin 18 which is arranged closer to the motor crank 10, and therefore the first articulated rod 20 for the passenger's side has a larger crank radius 28 than the second articulated rod 22 for the driver's side, which articulated rod 22 is provided on that ball pin 38 of the double ball pin 18 which is arranged further away from the motor crank 10. Owing to the fact that the lower crank radius 28 is designed to be larger here than the upper crank radius 34, it is possible not to increase the construction space requirement of the wiper linkage.

The realization of the angled arrangement of the axes of symmetry 32, 30 to each other is realized, for example, as illustrated in FIG. 7, by the motor crank 10 having a single offset, and therefore the first end section 14 is arranged at an angle to the second end section 16 of the motor crank 10. Furthermore, however, it is also possible, as shown in FIG. 8, for the motor crank 10 to have a double offset.

If the axis of symmetry 30 of the double ball pin 18 is inclined in the direction of the axis of symmetry 32 of the connecting element 12, the crank radius can be enlarged at the lower ball pin 36 in comparison to the known wiper linkages with axes of symmetry 30, 32 running parallel to each other, without increasing the construction space requirement. This permits use of the wiper linkage according to the invention in a wide variety of vehicle applications.

FIG. 9 shows a further possible embodiment in which the motor crank likewise has a double offset, but the axis of symmetry 30 of the double ball pin 18 is inclined away from the axis of symmetry 32 of the connecting element 12. In this embodiment, the articulated rod which is arranged on the upper ball pin 38 of the double ball pin 18 has a larger crank radius and a smaller output angle than the articulated rod which is arranged on the lower ball pin 36.

1. A wiper linkage of a windshield wiper system for a motor vehicle, comprising
a motor crank (10) with a first end section (14) and a second end section (16),
wherein the motor crank (10) is connected at the first end section (14) thereof to a driving motor via a connecting element (12), and
wherein the motor crank (10) has, at the second end section (16) thereof, a double ball pin (18) which is connected to a first articulated rod (20) and a second articulated rod (22),
wherein a first crank radius (28) is transmittable to the first articulated rod (20) and a second crank radius (34) is transmittable to the second articulated rod (22) by a rotational movement of the motor crank (10),
characterized in that
the first crank radius (28) of the first articulated rod (20) differs in size from the second crank radius (34) of the second articulated rod (22).

2. The wiper linkage as claimed in claim 1, characterized in that the double ball pin (18) has an axis of symmetry (30) which is provided at an angle to the axis of symmetry (32) of the connecting element (12).

3. The wiper linkage as claimed in claim 2, characterized in that the axis of symmetry (30) of the double ball pin (18) is inclined in the direction of the axis of symmetry (32) of the connecting element (12).

4. The wiper linkage as claimed in claim 2, characterized in that the axis of symmetry (30) of the double ball pin (18) is inclined away from the axis of symmetry (32) of the connecting element (12).

5. The wiper linkage as claimed in claim 2, characterized in that the second end section (16) is formed at an angle to the first end section (14) of the motor crank (10).

6. The wiper linkage as claimed in claim 5, characterized in that the motor crank (10) has a single offset.

7. The wiper linkage as claimed in claim 5, characterized in that the motor crank (10) has a double offset.

8. A windshield wiper system for a motor vehicle, comprising a wiper linkage as claimed in claim 1.
